(19) United States
(12) Patent Application Publication
(10) Pub. No.: US 2007/0263280 A1
(43) Pub. Date: Nov. 15, 2007

(54) ABERRATION-TOLERANT FAR INFRARED IMAGING SYSTEMS

(75) Inventors: Kenneth Ashley Macon, Longmont, CO (US); Joel Francis Rutkowski, Ward, CO (US); Miodrag Scepanovic, Boulder, CO (US); Hans Brandon Wach, Longmont, CO (US); Vladislav V. Chumachenko, Longmont, CO (US)

Correspondence Address: LATHROP & GAGE LC, 4845 PEARL EAST CIRCLE, SUITE 300, BOULDER, CO, 80301, US

(73) Assignee: CDM OPTICS, INC., Boulder, CO (US)

(21) Appl. No.: 11/746,458

(22) Filed: May 9, 2007

Related U.S. Application Data
(60) Provisional application No. 60/798,986, filed on May 9, 2006.

(51) Int. Cl. G06K 7/10

(52) U.S. Cl. 359/350

(57) ABSTRACT

A far infrared imaging system includes one or more optical elements that effects a predetermined phase modification, a detector that converts an image formed by the one or more optical elements into electronic data, and a post processor for processing the electronic data.

### RELATED APPLICATIONS

This application claims priority to U.S. provisional application Ser. No. 60/798,986, filed May 9, 2006, entitled FAR INFRARED CAMERA SYSTEM, which application is incorporated herein by reference.

### BACKGROUND

Automotive applications may advantageously use images formed in the infrared (“IR”) spectrum, since living objects typically emit IR radiation. Such radiation, though invisible to humans, may be “seen” by IR cameras even at night when natural light may be unavailable or too dim to form a useful image.

### SUMMARY

A far IR imaging system includes one or more optical elements that implements a predetermined phase modification, a detector that converts an image formed by the one or more optical elements into electronic data, and a post processor for processing the electronic data. The system may further include a display device for displaying the electronic data so processed.

### BRIEF DESCRIPTION OF DRAWINGS

FIG. 1 shows a far IR imaging system, in accordance with an embodiment.

FIGS. 2 and 3 show design details of optical elements suitable for use in the far IR imaging system of FIG. 1.

FIGS. 4-6 show plots of modulation transfer functions (MTFs) for 0° and 12° incidence angles for a “traditional” imaging system (i.e., without a predetermined phase modification included therein) at three different temperature settings for an object located at 100 m from the imaging system.

FIGS. 7-9 show plots of MTFs for 0° and 12° incidence angles for a far IR imaging system including a predetermined phase modification, in accordance with an embodiment, for the three different temperature settings for the object at 100 m from the imaging system.

FIGS. 10-12 show plots of modulation transfer functions (MTFs) for 0° and 12° incidence angles for the traditional imaging system at three different temperature settings for an object located at 10 m from the imaging system.

FIGS. 13-15 show plots of MTFs for 0° and 12° incidence angles for a far IR imaging system including a predetermined phase modification, in accordance with an embodiment, for the three different temperature settings for the object at 10 m from the imaging system.

FIGS. 16-18 show 2-D, 3-D and tabular representations of an aggressive filter kernel for use in processing images captured by the far IR imaging system, in accordance with an embodiment.

FIGS. 19-21 show 2-D, 3-D and tabular representations of a soft filter kernel for use in processing images captured by the far IR imaging system, in accordance with an embodiment.

FIG. 22 shows a plot of reconstruction filter MTFs of the far IR imaging system using the aggressive and soft filter kernels, in accordance with an embodiment.

FIGS. 23-25 show plots of MTFs after post-processing for different incidence angles for the far IR imaging system including a predetermined phase modification, in accordance with an embodiment, for the three different temperature settings for the object at 10 m from the imaging system.

FIGS. 26 and 27 show a side view and a front view, respectively, of an exemplary automobile including a plurality of far IR imaging systems mounted thereon, in accordance with an embodiment.

### DETAILED DESCRIPTION OF DRAWINGS

It would be desirable to implement a far IR imaging system that is robust, cost-effective and tolerant of aberrations. Aberrations may be induced by, for example, temperature variations and/or misalignment during assembly of the imaging system. For example, if the far IR imaging system is to be used in an automobile as a part of a pedestrian or obstacle detection system, the far IR imaging system should be compact, readily integratable with the existing automobile computer and electronics systems and be able to withstand a large fluctuation in operating temperature, such as from −40° C. to +85° C. In addition, the far IR imaging system should exhibit good field of view performance such as, for instance, 12° Half Field of View (“HFoV”).

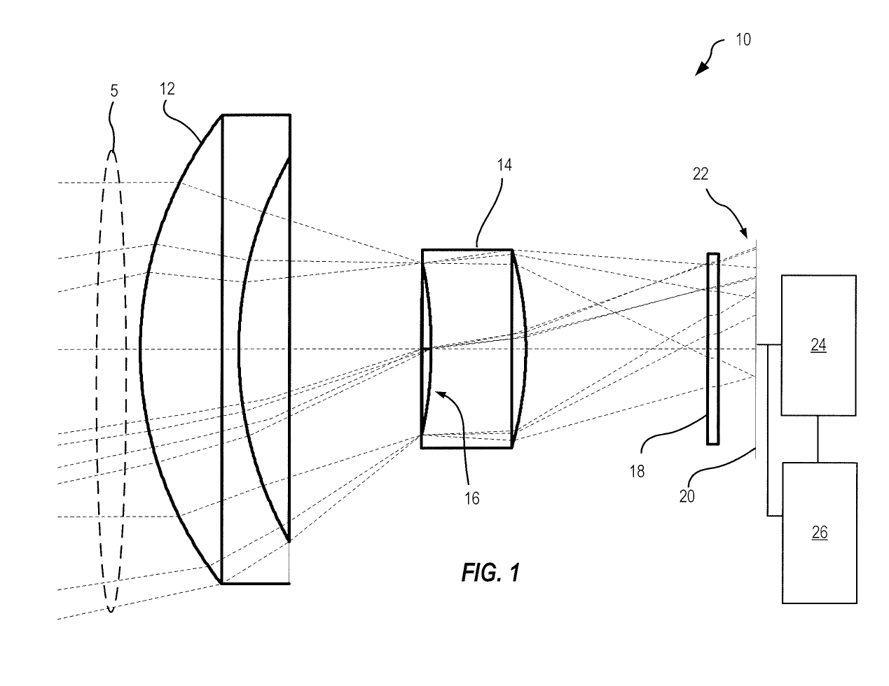

FIG. 1 shows a far IR imaging system 10. System 10 includes optical elements 12 and 14 and a detector 20, and may include an optional window 18. System 10 images electromagnetic energy such as light rays 5 to an image 22 that is captured by detector 20. The electromagnetic energy forming light rays 5 may be, for example, in the visible and/or IR spectra. A surface 16 of optical element 14 is a specialized phase surface that imparts a predetermined phase function to light rays 5; in particular, surface 16 may encode a wavefront of light rays 5 with a predetermined phase function such as, for example, a higher order separable (“HOS”) or a constant profile path (“CPP”) phase function. HOS or CPP phase functions, or other phase functions, may be chosen and/or optimized for a given application based on factors such as simplicity of fabrication of optical element 14, visual appearance of artifacts, and signal-to-noise ratio generated thereby. To facilitate imaging in the IR spectrum, optical elements 12 and 14 (e.g., including surface 16) may be formed of, for example, optical grade germanium and/or other materials optimized for transmission in the IR spectrum. It is appreciated that more or fewer optical elements than the two optical elements 12 and 14 shown in FIG. 1 may be utilized to form image 22 in system 10.

Detector 20 converts image 22 to an electronic image that may, optionally, be processed by a post processor 24 (e.g., a microprocessor or computer operating under software control) and displayed on a display device 26. Alternatively, detector 20 may provide the electronic image directly to display device 26. Post processor 24 may implement one or more filters to sharpen images blurred by surface 16 of optical element 14 and, optionally, to increase a modulation transfer function (“MTF”) of system 10. Post processor 24 may also implement temperature dependent filtering.

In certain embodiments, a phase function imparted by surface 16 of optical element 14 may be rotationally asymmetric; in such cases, minimization of effects such as aliasing and/or interaction with post processing may be facilitated by rotational alignment of optical element 14 with respect to detector 20. In one such embodiment, alignment may be facilitated by mechanical means such as, for example, notches, grooves or flats that can be sensed and/or manipulated during assembly, on either or both of optical element 14 and detector 20. In another such embodiment, optical element 14 and/or detector 20 may include fiducial marks that can be imaged and aligned by humans or by machine vision equipment. In yet another such embodiment, system 10 may be assembled and functional with at least one of optical element 14 and detector 20 being rotatable. Then, rotational alignment of optical element 14 with respect to detector 20 may be adjusted, with a human or machine vision system observing and optimizing images formed by system 10, and the position of optical element 14 and detector 20 may be rotationally fixed when the image is optimized.

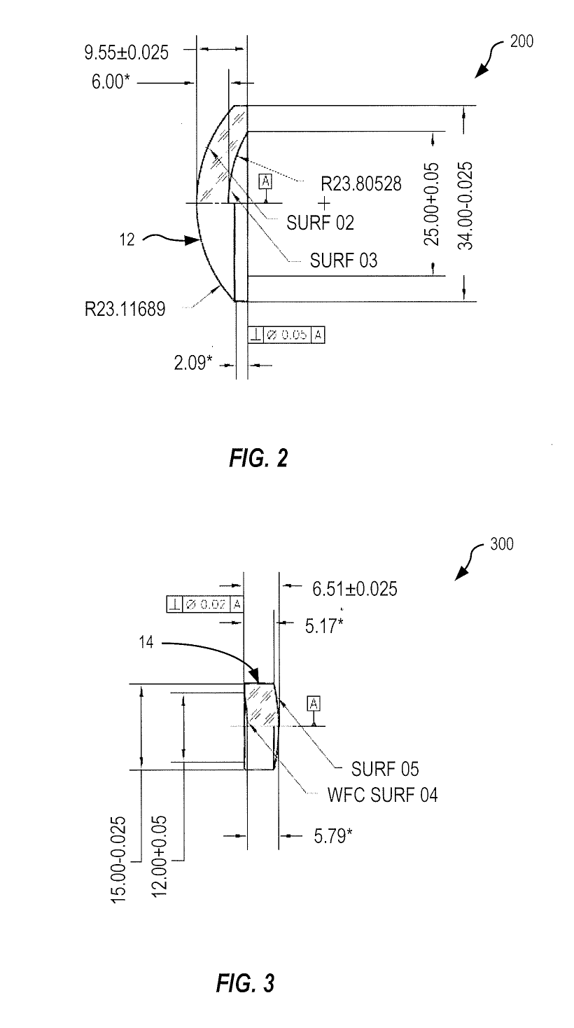

FIG. 2 shows details of an exemplary design 200 for optical element 12, FIG. 1. In exemplary design 200, optical element 12 is formed of an optical grade germanium (Ge). Optical element 12 includes a first surface (labeled “SURF 02”) and a second surface (labeled “SURF 03”). The numerical values shown in FIG. 2 are given in units of millimeters. The clear aperture (“CA”) diameter of SURF 02 is 28.7860 mm, while the CA of SURF 03 is 23.6260 mm in exemplary design 200. The maximum point of vertical tangent (PVT) sag within the CA on SURF 02 is 5.0270 mm, while the maximum PVT sag within the CA on SURF 03 is 3.1380 mm. In exemplary design 200, the maximum surface roughness may be expressed as Rd=3.00 nm and Rz=50.00 nm. The maximum wedge between SURF 02 and SURF 03 is 5°, while the maximum decenter between SURF 02 and SURF 03 is specified as 0.025 mm. Furthermore, departure from surface form is specified to not exceed 0.005 mm in this exemplary design, and the central thickness (6.00 mm) tolerance is specified to be ±0.025 mm.

FIG. 3 shows details of an exemplary design 300 for optical element 14, FIG. 1. In exemplary design 300, optical element 14 is formed of an optical grade infrared material, such as GASIR® available from Umicore Optics. Optical element 14 includes a first surface (labeled “WFC SURF 04”), wherein WFC is short for wavefront coding, and a second surface (labeled “SURF 05”). Again, the numerical values shown in FIG. 3 are given in units of millimeters. The CA diameter of WFC SURF 04 is specified as 10.5171 mm, while the CA diameter of SURF 05 is given by 12.0946 mm. The maximum PVT sag within the CA on WFC SURF 04 is −0.5798 mm, while the maximum PVT sag within the CA on SURF 05 is specified to be −0.8675 mm. In exemplary design 300, the maximum surface roughness is again given as Rd=3.00 nm and Rz=50.00 nm. Also, the maximum wedge between WFC SURF 04 and SURF 05 is 5°, and the maximum decenter between WFC SURF 04 and SURF 05 should be 0.025 mm. The central thickness (5.79 mm) is specified to within tolerances of ±0.025 mm.

Further details of WFC SURF 04 are given by Eqs. (1)-(5) and TABLE 1.

TABLE 1

| | |
|---|---|
| | Eq. (1) |
| $sag = \frac{c \cdot {r}^{2}}{1 + {( 1 - ( 1 + k ) \cdot {c}^{2} \cdot {r}^{2} )}^{1 / 2}} + {α}_{2} \cdot {r}^{2} + {α}_{4} \cdot {r}^{4} + {α}_{6} \cdot {r}^{6} + {WFC}_{sag} ;$ | |
| | Eq. (2) |
| ${WFC}_{sag} = {10}^{- 3} \cdot ( sagX + sagY ) ;$ | |
| | Eq. (3) |
| $sagX = {A}_{3} \cdot sign ( x ) \cdot {\vert \frac{x}{r} \vert}^{3} + {A}_{5} \cdot sign ( x ) \cdot {\vert \frac{x}{r} \vert}^{5} ;$ | |
| | Eq. (4) |
| $sagY = {A}_{3} \cdot sign ( y ) \cdot {\vert \frac{y}{r} \vert}^{3} + {A}_{5} \cdot sign ( y ) \cdot {\vert \frac{y}{r} \vert}^{5} ;$ | |
| | Eq. (5) |
| $sign ( param ) = \{ \begin{matrix}1 , param > 0 \\ - 1 , param \leq 0\end{matrix} ;$ | |

| Parameter (units) | Definition | Value |
|---|---|---|
| c (1/mm) | Curvature | −0.36887 |
| r (mm) | Radius of CA | 5.25853 |
| k | Conic constant | −1.02267 |
| α₂ (1/mm) | 2^{nd} order aspheric coefficient | 0.16631 |
| α₄ (1/mm³) | 4^{th} order aspheric coerfficient | −2.35550 × 10⁻⁴ |
| α₆ (1/mm⁵) | 6^{th} order aspheric coefficient | 6.96520 × 10⁻⁷ |
| A₃ (μm) | 3^{rd} order WFC coefficient | 15.41250 |
| A₅ (μm) | 5^{th} order WFC coefficient | 2.88130 |

Similarly, further details of SURF 05 are given by Eq. (6) and TABLE 2.

TABLE 2

| | |
|---|---|
| | Eq. (6) |
| $sag = \frac{c \cdot {r}^{2}}{1 + {( 1 - ( 1 + k ) \cdot {c}^{2} \cdot {r}^{2} )}^{1 / 2}} + {α}_{2} \cdot {r}^{2} + {α}_{4} \cdot {r}^{4} + {α}_{6} \cdot {r}^{6} ;$ | |

| Parameter (units) | Definition | Value |
|---|---|---|
| c (1/mm) | Curvature | −0.62416 |
| r (mm) | Radius of CA | 6.04732 |
| k | Conic constant | −0.99574 |
| α₂ (1/mm) | 2^{nd} order aspheric coefficient | 0.28929 |
| α₄ (1/mm³) | 4^{th} order aspheric coefficient | 9.26257 × 10⁻⁵ |
| α₆ (1/mm⁵) | 6^{th} order aspheric coefficient | 4.20636 × 10⁻⁷ |

When the optical elements shown in FIGS. 2 and 3 are included in system 10 of FIG. 1, the result is a fast, far IR imaging system with an effective focal length (“EFL”) of 28.95 mm, f-number (“F/#”) of 1.41, HFoV of 12° with maximum distortion of 1.8% and minimum relative illumination of 82% at this HFoV value. The total optical track (“TOTR”) of this system, which is defined as a distance from the front surface of optical element 12 to detector 20, is 38 mm.

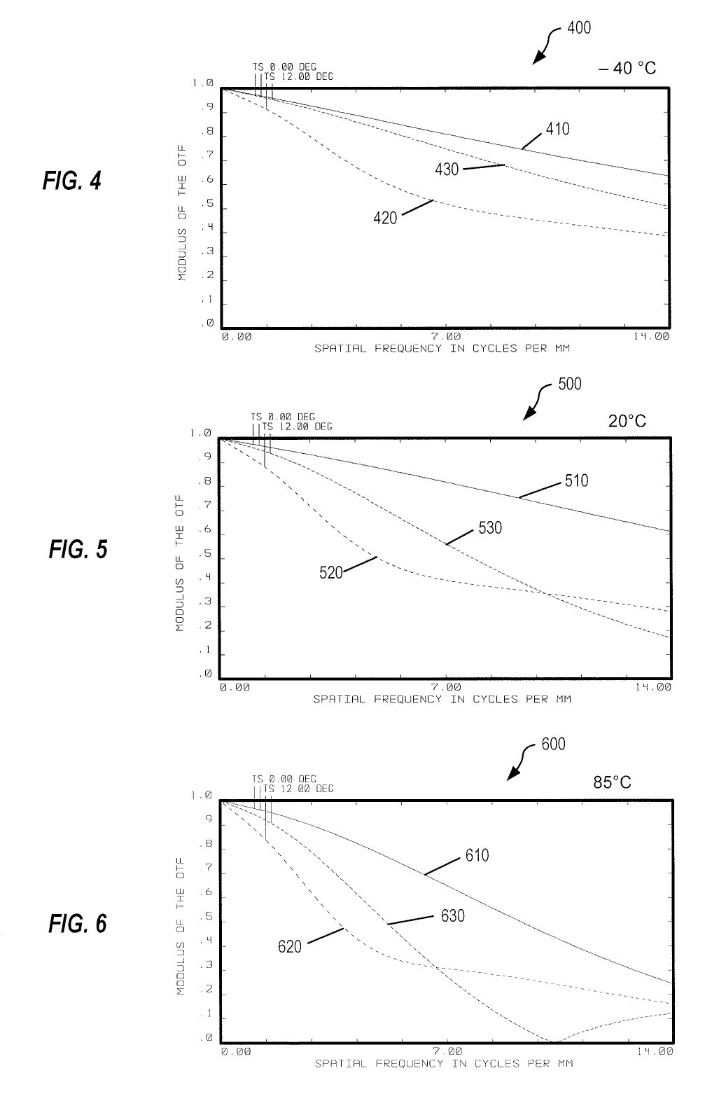

Comparisons of the performance of far IR imaging system 10 with and without the specialized phase surface are discussed immediately hereinafter. FIGS. 4-6 show MTF plots 400, 500 and 600, respectively, for on-axis (0° incidence angle) and off-axis (12° incidence angle) light rays entering a traditional far IR imaging system without a specialized phase surface (i.e., without WFC SURF 04) for an object located at 100 m from the imaging system at temperatures of −40° C., +20° C. and +85° C., respectively. MTF plot 400 of FIG. 4 includes a solid line 410 for the on-axis MTF. It should be noted that, in the context of the present disclosure, the on-axis MTF includes a tangential MTF and a sagittal MTF that are virtually overlapped. Furthermore, MTF plot 400 includes an off-axis, tangential MTF 420 and an off-axis, sagittal MTF 430. MTF plot 500 of FIG. 5 includes a solid line 510 for the on-axis MTF, an off-axis, tangential MTF 520 and an off-axis, sagittal MTF 530. MTF plot 600 of FIG. 6 includes a solid line 610 for the on-axis MTF, an off-axis, tangential MTF 620 and an off-axis, sagittal MTF 630. As may be seen in FIGS. 4-6, the MTFs vary widely between on- and off-axis incidence angles and for different temperatures.

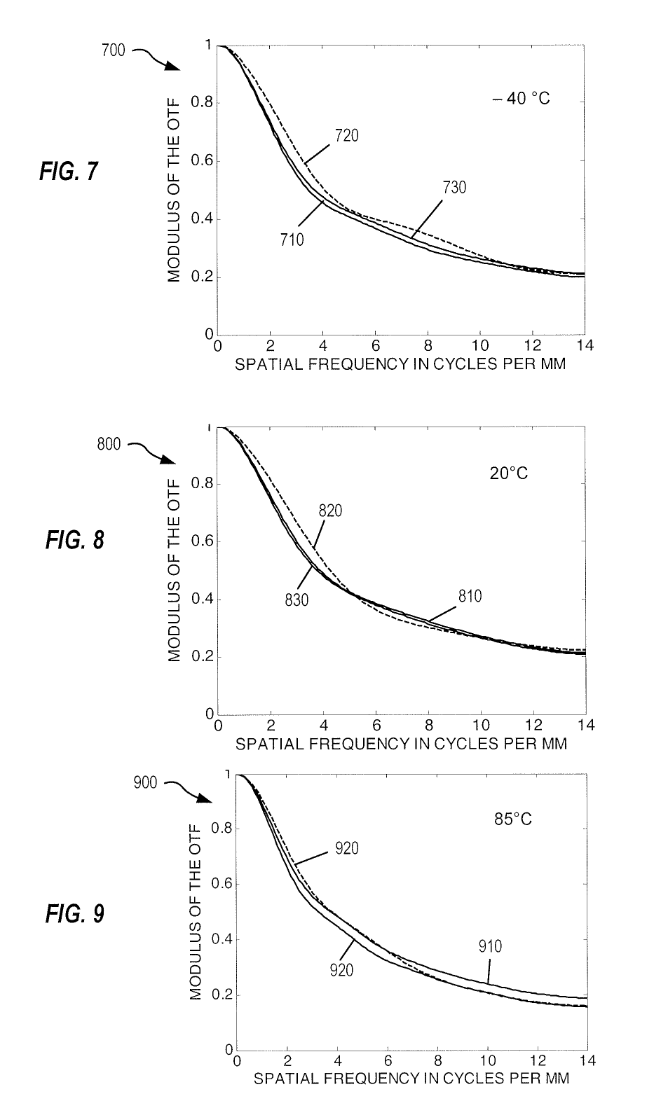

FIGS. 7-9 show MTF plots for on-axis (0° incidence angle) and off-axis (12° incidence angle) light rays entering far IR imaging system 10 including specialized phase surface 16 (i.e., including WFC SURF 04) for an object located at 100 m from the imaging system at temperatures of −40° C., +20° C. and +85° C., respectively. MTF plot 700 of FIG. 7 includes a solid line 710 for the on-axis MTF, an off-axis, tangential MTF 720 and an off-axis, sagittal MTF 730. MTF plot 800 of FIG. 8 includes a solid line 810 for the on-axis MTF, an off-axis, tangential MTF 820 and an off-axis, sagittal MTF 830. MTF plot 900 of FIG. 9 includes a solid line 910 for the on-axis MTF, an off-axis, tangential MTF 920 and an off-axis, sagittal MTF 930. As may be seen in FIGS. 7-9, the MTFs for the on-axis rays (indicated by the dashed line) and the off-axis rays (indicated by the solid lines) are quite similar in shape and magnitude and do not vary as much as the MTFs shown in FIGS. 4-6 for the traditional system.

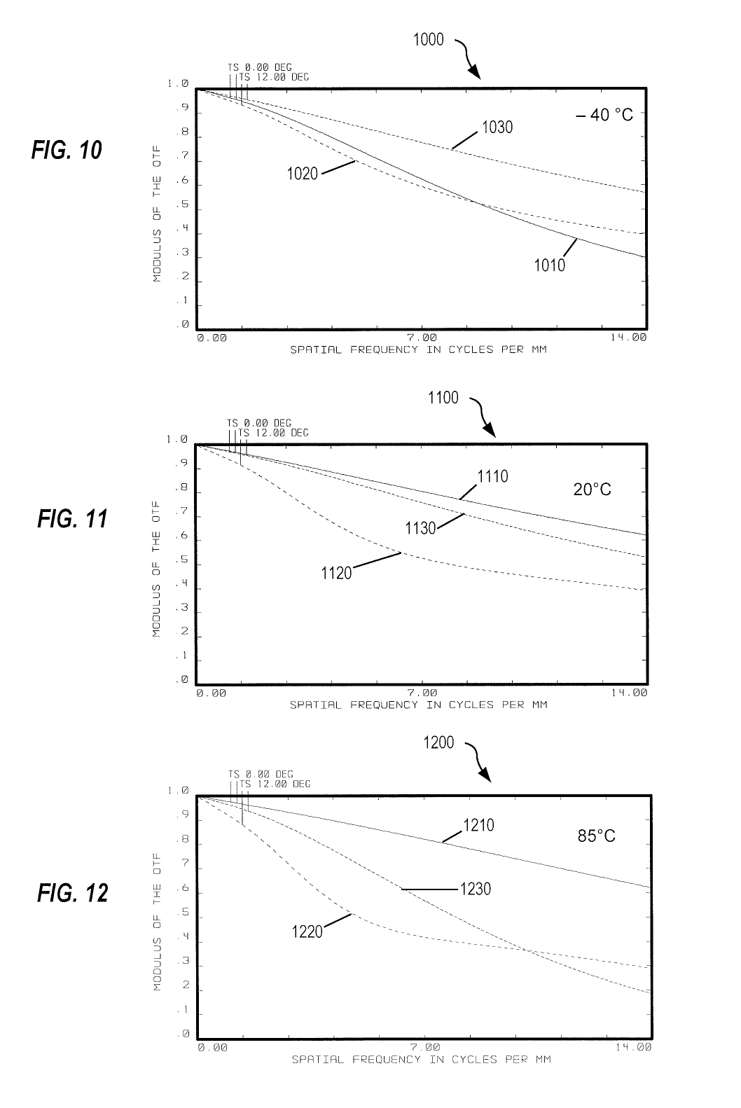

Similarly, FIGS. 10-12 show MTF plots for on-axis (0° incidence angle) and off-axis (12° incidence angle) light rays entering a traditional far IR imaging system without a specialized phase surface (i.e., without WFC SURF 04) for an object located at 10 m from the imaging system at temperatures of −40° C., +20° C. and +85° C., respectively. MTF plot 1000 of FIG. 10 includes a solid line 1010 for the on-axis MTF, an off-axis, tangential MTF 1020 and an off-axis, sagittal MTF 1030. MTF plot 1100 of FIG. 11 includes a solid line 1110 for the on-axis MTF, an off-axis, tangential MTF 1120 and an off-axis, sagittal MTF 1130. MTF plot 1200 of FIG. 12 includes a solid line 1210 for the on-axis MTF, an off-axis, tangential MTF 1220 and an off-axis, sagittal MTF 1230. Again, the MTFs vary widely between on- and off-axis incidence angles and for different temperatures in the traditional imaging system.

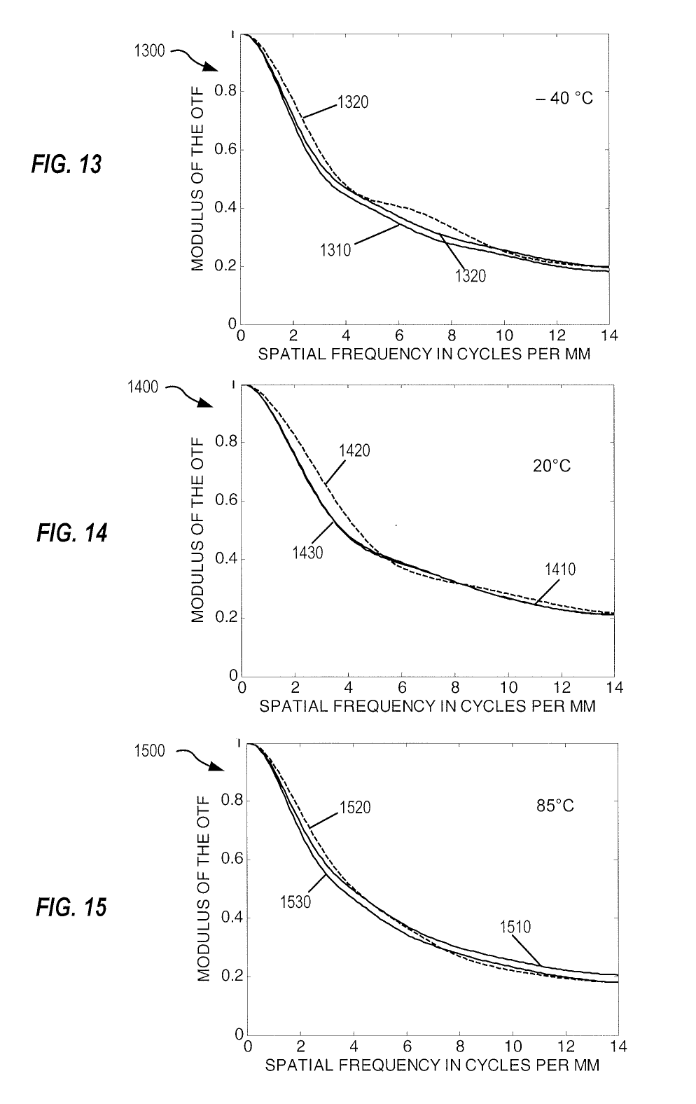

FIGS. 13-15 show MTF plots for on-axis (0° incidence angle) and off-axis (12° incidence angle) light rays entering far IR imaging system 10 including specialized phase surface 16 (i.e., including WFC SURF 04) for an object located at 10 m from the imaging system at temperatures of −40° C., +20° C. and +85° C., respectively. MTF plot 1300 of FIG. 13 includes a solid line 1310 for the on-axis MTF, an off-axis, tangential MTF 1320 and an off-axis, sagittal MTF 1330. MTF plot 1400 of FIG. 14 includes a solid line 1410 for the on-axis MTF, an off-axis, tangential MTF 1420 and an off-axis, sagittal MTF 1430. MTF plot 1500 of FIG. 15 includes a solid line 1510 for the on-axis MTF, an off-axis, tangential MTF 1520 and an off-axis, sagittal MTF 1530. As notable in FIGS. 13-15, the MTFs for the on-axis rays (indicated by the dashed line) and the off-axis rays (indicated by the solid lines) are again quite similar in shape and magnitude and do not vary as much as the MTFs shown in FIGS. 10-12 for the traditional system.

Tolerance analysis may also be performed for the combination of optical elements in system 10 using, for instance, optical system design software such as ZEMAX®. In the present case, relative change in MTF values, relative to nominal design, may be considered to provide an estimate of the expected tolerances. The results of the tolerance analysis for positive tolerance are summarized in TABLE 3. In the context of the tolerance analysis, “MTFA” stands for the average value of the tangential and sagittal MTF at a given spatial frequency.

TABLE 3

| | | On-Axis | | | Off-Axis | | |
|---|---|---|---|---|---|---|---|
| | | (0° incidence angle) | | | (12° incidence angle) | | |
| | | MTFA change (%) | | | MTFA change (%) | | |
| | Tolerance | 4 lp/mm | 7 lp/mm | 14 lp/mm | 4 lp/mm | 7 lp/mm | 14 lp/mm |
| Optical element 12 | | | | | | | |
| Dec elem X (mm) | 0.1 | 2 | 2 | 1 | 1 | 1 | 7 |
| Dec surf X (mm) | 0.1 | 4 | 3 | 2 | 8 | 0 | 11 |
| Dec elem Y (mm) | 0.1 | 2 | 2 | 1 | 2 | 3 | 4 |
| Dec surf Y (mm) | 0.1 | 4 | 3 | 2 | 8 | 20 | 30 |
| Tilt elem X (°) | 1 | 1 | 1 | 1 | 1 | 3 | 4 |
| Tilt surf X (°) | 1 | 9 | 12 | 25 | 10 | 8 | 18 |
| Tilt elem Y (°) | 1 | 1 | 1 | 1 | 2 | 8 | 25 |
| Tilt surf Y (°) | 1 | 7 | 6 | 5 | 8 | 2 | 20 |
| Thickness (mm) | 0.1 | 11 | 9 | 12 | 3 | 15 | 7 |
| Optical element 14 | | | | | | | |
| Dec elem X (mm) | 0.1 | 1 | 1 | 3 | 2 | 2 | 3 |
| Dec surf X (mm) | 0.1 | 4 | 4 | 0 | 4 | 2 | 20 |
| Dec elem Y (mm) | 0.1 | 1 | 1 | 3 | 2 | 2 | 3 |
| Dec surf Y (mm) | 0.1 | 4 | 4 | 0 | 14 | 2 | 6 |
| Tilt elem X (°) | 1 | 0 | 0 | 0 | 3 | 12 | 13 |
| Tilt surf X (°) | 1 | 2 | 2 | 4 | 1 | 8 | 5 |
| Tilt elem Y (°) | 1 | 0 | 0 | 0 | 2 | 4 | 12 |
| Tilt surf Y (°) | 1 | 2 | 2 | 2 | 1 | 1 | 2 |
| Thickness (mm) | 0.1 | 0 | 0 | 0 | 2 | 6 | 3 |
| Spacing: Optical | 0.25 | 8 | 12 | 12 | 1 | 5 | 4 |
| element 12 to 14 | | | | | | | |
| Spacing: Optical | 0.25 | 8 | 13 | 11 | 1 | 1 | 4 |
| element 14 to detector | | | | | | | |

One consideration in the tolerance analysis is the rotational alignment tolerance of optical element 14 due to the sag asymmetry in WFC SURF 04. Typically, the tolerance on this rotational alignment is approximately ±1°. A variety of options are available for facilitating this rotational alignment, depending on the specific opto-mechanical design and assembly method used in the assembly of system 10. For instance, a notch or v-groove may be incorporated into the edge of optical element 14 for interfacing with a mechanical housing. As another example, corresponding fiducial marks may be placed on a housing and on optical element 14, outside of the clear aperture. Alternatively, a flat surface may be formed at an edge of optical element 14 for assisting with the angular alignment. These and other alignment methods are disclosed, for example, in PCT patent application serial number PCT/US07/09347, entitled ARRAYED IMAGING SYSTEMS AND ASSOCIATED METHODS, filed on Apr. 17, 2007.

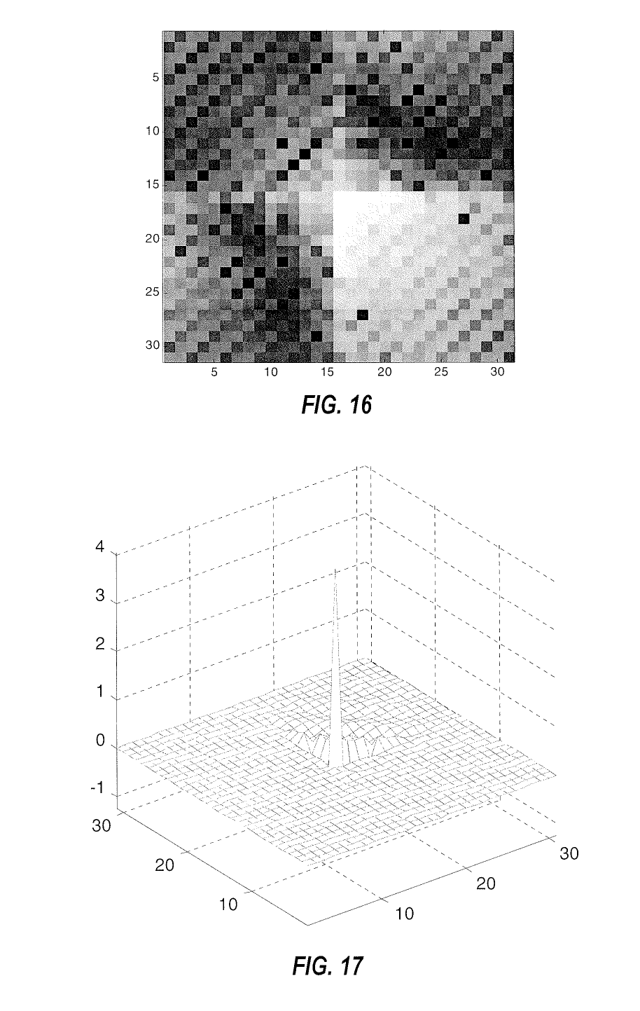

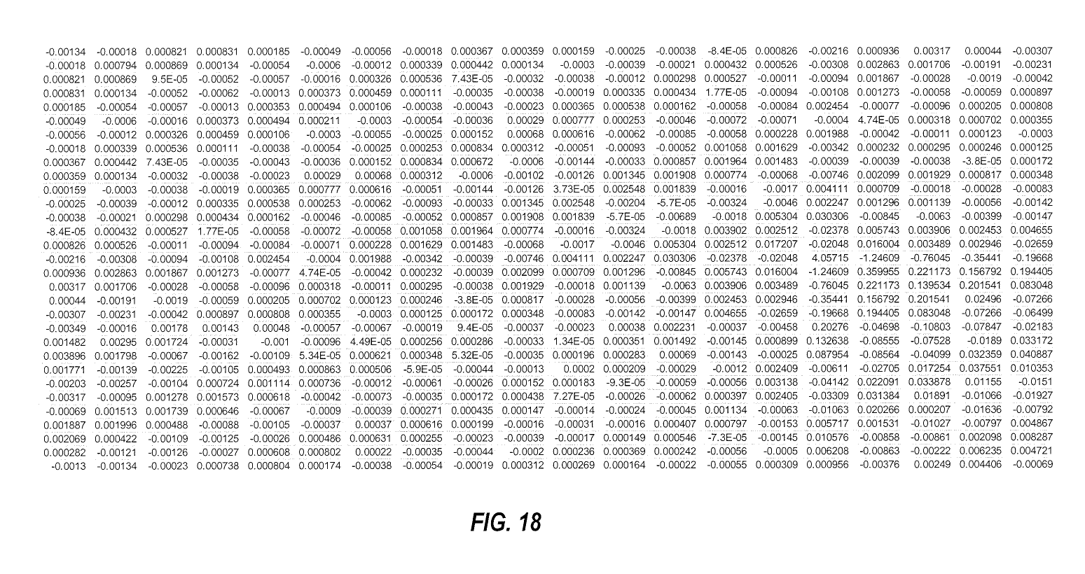

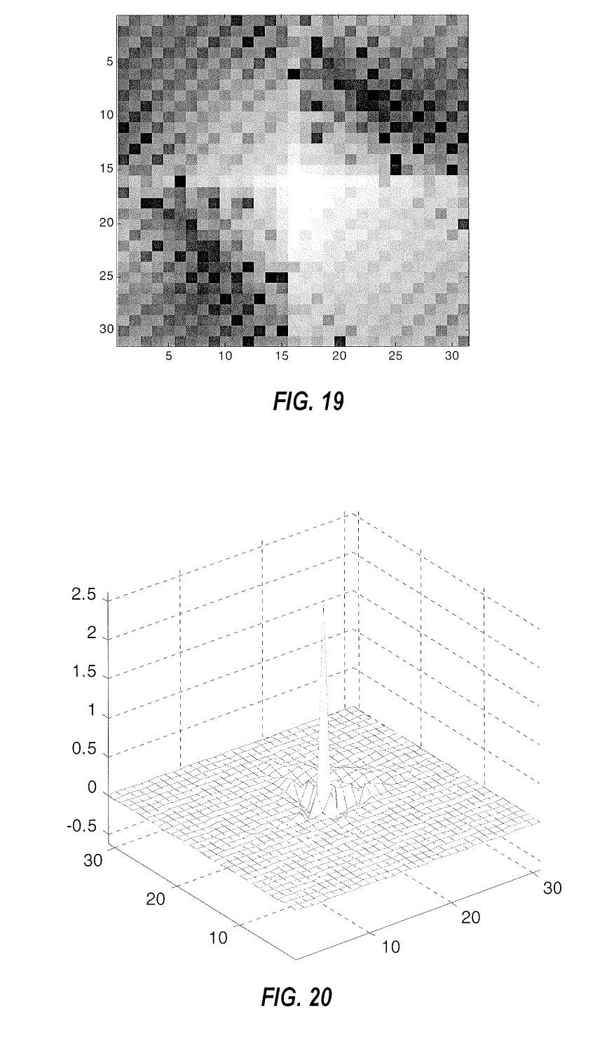

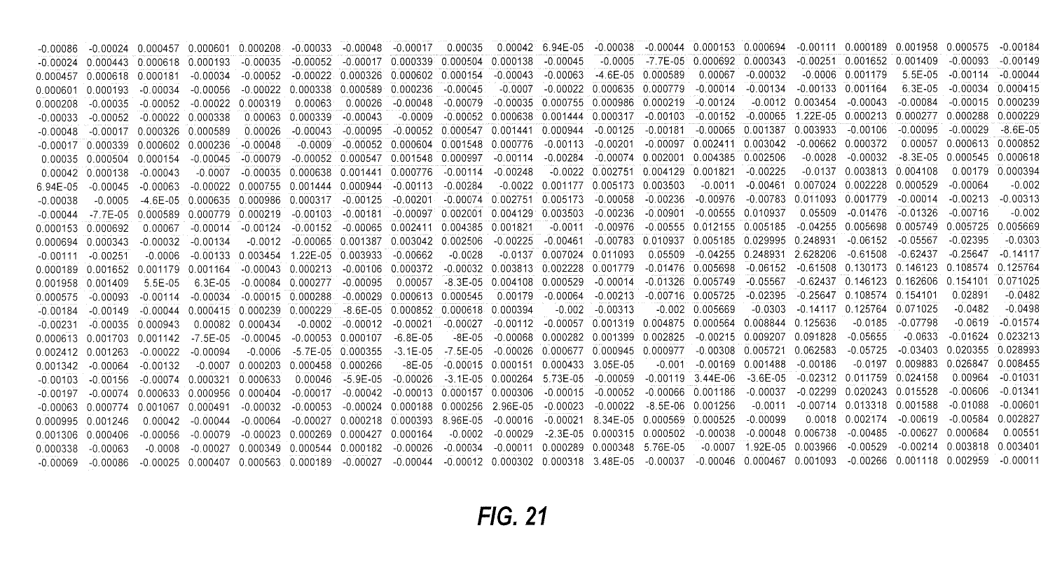

Image 22 formed at detector 20 may be “reconstructed” at post processor 24 implementing a reconstruction filter. FIGS. 16-18 show 2-D, 3-D and tabular representations, respectively, of an exemplary “aggressive” filter kernel that may be implemented in post processor 24, FIG. 1. Similarly, FIGS. 19-21 show 2-D, 3-D and tabular representations, respectively, of an exemplary “soft” filter kernel that may be implemented in post processor 24, FIG. 1. Both the aggressive and soft filter kernels are 31×31 element filter kernels built using on-axis, best aliased polychromatic point spread functions (“PSFs”) at −40° C., +20° C. and +85° C. for an object distance of 10 meters; in other words, three different PSFs were used in the design of the filter kernels. Both of these filter kernels may be further optimized at the system level, in accordance with the final optical system design, detector design and application requirements. While the aggressive and soft filter kernels are shown as floating point kernels (see FIGS. 18 and 21), these kernels may readily be modified to be integer kernels.

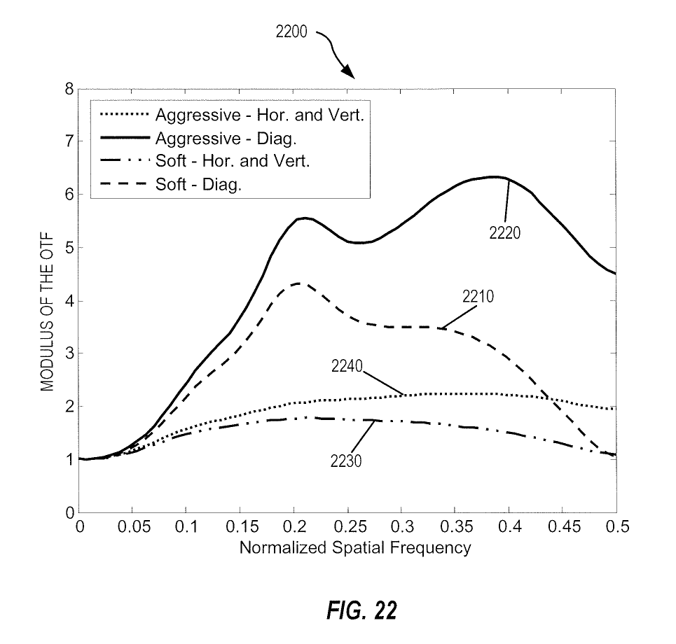

The differences between the behaviors of the aggressive and soft filter kernels in the post processing are shown in FIG. 22. FIG. 22 includes a plot 2200 of MTFs as a function of normalized spatial frequency for different directions using the aggressive and soft filter kernels. A dashed line 2210 corresponds to the MTF in the horizontal and vertical directions with the aggressive filter, while a solid line 2220 corresponds to the MTF in the diagonal directions using the aggressive filter. A dash-dot line 2230 corresponds to the MTF in the horizontal and vertical directions with the soft filter, while a dotted line 2240 corresponds to the MTF in the diagonal directions using the soft filter. With both the aggressive and soft filter kernels, the use of the HOS phase function in WFC SURF 04 results in reconstruction filters that have a much higher gain on the diagonal than in the horizontal and vertical directions, as shown in FIG. 22.

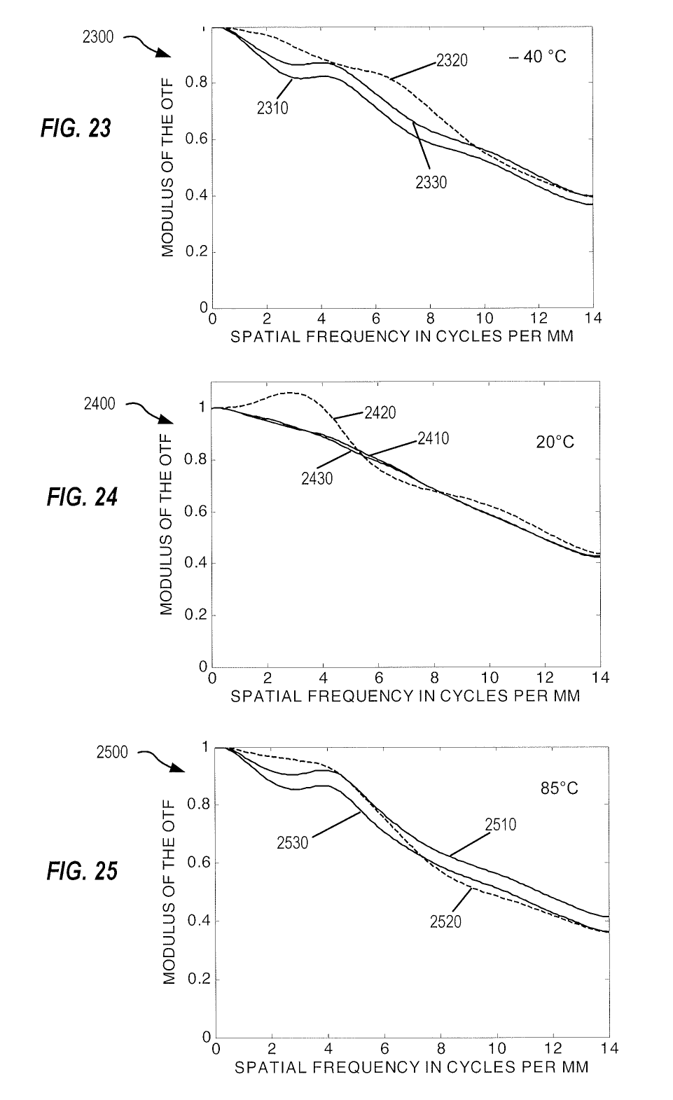

FIGS. 23-25 show the MTFs, after post processing with the aggressive filter for an object distance of 10 meters. MTF plot 2300 of FIG. 23 includes a solid line 2310 for the on-axis MTF, an off-axis, tangential MTF 2320 and an off-axis, sagittal MTF 2330. MTF plot 2400 of FIG. 24 includes a solid line 2410 for the on-axis MTF, an off-axis, tangential MTF 2420 and an off-axis, sagittal MTF 2430. MTF plot 2500 of FIG. 25 includes a solid line 2510 for the on-axis MTF, an off-axis, tangential MTF 2520 and an off-axis, sagittal MTF 2530. In comparing FIGS. 23-25 with FIGS. 10-12 (MTFs for the traditional far IR imaging system) and 13-15 (MTFs for the far IR imaging system including the specialized phase surface in accordance with the embodiment shown in FIGS. 1-3), it may be seen that post-processing with the aggressive filter kernel results in MTFs that are similar in magnitude to the MTFs of the traditional far IR imaging system while maintaining the similarity in the contours among the on- and off-axis MTFs at different temperatures. In other words, the combination of the specialized phase surface and the post processing results in imaging performance that is tolerant to different incident angles as well as temperature variations.

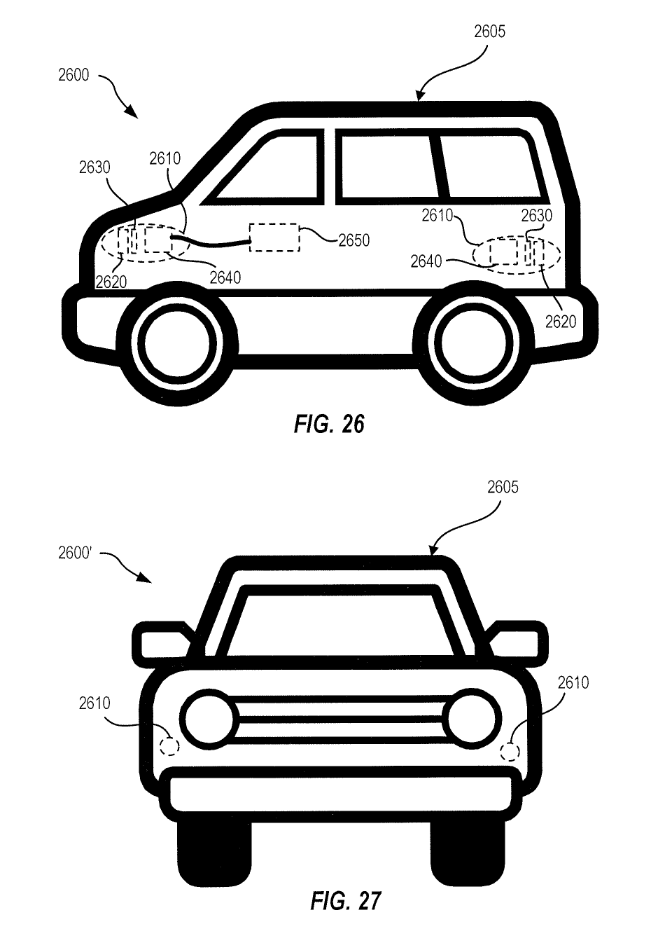

FIGS. 26 and 27 illustrate exemplary embodiments of the aberration-tolerant far IR imaging systems in an automobile. FIG. 26 shows a side view 2600 of an automobile 2605 including two far IR imaging systems 2610 therein. Each of far IR imaging systems 2610 includes optics 2620 connected with a detector 2630 and imaging system electronics 2640. FIG. 27 shows a front view 2600′ of automobile 2605, illustrating additional far IR imaging systems 2610 incorporated into the front of the automobile. Imaging system electronics may be connected with automobile electronics 2650 so as to feed information into, for example, a navigation system of automobile 2600. Far IR imaging systems 2610 may perform assist in functions such as, but not limited to, pedestrian or obstacle recognition and avoidance or automatic navigation.

Changes may be made in the far IR imaging system described herein without departing from the scope hereof. For example, while FIGS. 1 and 3 show the predetermined phase function to be implemented at a given surface (i.e., WFC SURF 04), the effect of the predetermined phase function may be implemented by a volume of material, such as disclosed in U.S. provisional application Ser. No. 60/792,444, filed Apr. 17, 2006, entitled IMAGING SYSTEM WITH NON-HOMOGENEOUS WAVEFRONT CODING OPTICS, which application is incorporated herein by reference. Also, the post processing may be selected in accordance with operating temperature, such as disclosed in G. E. Johnson et al., “Passive ranging through wave-front coding: information and application,” Appl. Opt., vol. 39, no. 11, pp. 1700-1720, 10 Apr. 2000. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A far infrared imaging system, comprising:
one or more optical elements for effecting a predetermined phase modification;
a detector that converts an image formed by the one or more optical elements into electronic data; and
a post processor for processing the electronic data.

2. The system of claim 1, wherein the predetermined phase modification comprises a phase function that is one of a higher order separable phase function and a constant profile path phase function.

3. The system of claim 1, further comprising a display device for displaying the electronic image.
